(19) United States
(12) Patent Application Publication
(10) Pub. No.: US 2014/0269227 A1
(43) Pub. Date: Sep. 18, 2014

(54) TIMEPIECE DEVICE AND METHOD OF OPERATION THEREOF

(71) Applicants: Borislav Bobev, Sofia (BG); Krassimire Stoyanov, Sofia (BG)

(72) Inventors: Borislav Bobev, Sofia (BG); Krassimire Stoyanov, Sofia (BG)

(73) Assignee: JOHNSON CONTROLS AUTOMOTIVE ELECTRONICS GMBH

(21) Appl. No.: 14/117,610

(22) PCT Filed: May 11, 2012
(86) PCT No.: PCT/EP2012/058822

§ 371 Date: Apr. 8, 2014

(30) Foreign Application Priority Data
May 14, 2011 (DE) 10 2011 101 611.6
Jun. 29, 2011 (EP) 11171958.9

(51) Int. Cl. G04G 7/00; G04G 3/04

(52) U.S. Cl. CPC G04G 7/00; G04G 3/04
USPC 368/159

(57) ABSTRACT

A timepiece device includes a control unit for time keeping, which is synchronizable by a clock generator. The timepiece device has at least two crystal oscillators built respectively by at least one crystal unit, whereby a first crystal oscillator with a first crystal unit and with a predetermined nominal oscillation frequency is suitable for use as the clock generator of the control unit during a vehicle standby mode, and whereby the oscillation frequency of the first crystal oscillator is at least temporarily measured and adjustable by a second crystal oscillator with a second crystal unit whose nominal oscillation frequency is higher than that of the first crystal oscillator. In a method of operation of the timepiece device, the oscillation frequency of the second crystal oscillator is compensated against the temperature by the software inside the control unit.

### TECHNICAL FIELD

The present invention relates to a timepiece device comprising a control unit that is synchronizable by a clock generator.

Furthermore, the present invention relates to a method of operation of a timepiece device.

### BACKGROUND OF THE INVENTION

Clocks with a conventional analogue movement and clocks with an analogue display powered by at least one stepped motor are well known by prior art. Furthermore, there are analogue and/or digital clocks known which use a crystal oscillator to keep time. This so-called quartz clock is the most widely-used timekeeping technology because of the very precise oscillation frequency of crystal oscillators realized by crystal units.

### SUMMARY OF THE INVENTION

It is an object of the present invention to provide an improved timepiece device, in particular for a vehicle, and an improved method of operation thereof, by means of which a very low average consumption current during a vehicle standby mode is required, while keeping an improved accuracy of the timepiece device in relation to prior art.

According to the invention, the object is achieved by a timepiece device according to claim 1 and a method according to claim 8.

Preferred embodiments of the invention are given in the dependent claims.

A timepiece device, in particular for a vehicle, comprises a control unit for timekeeping, which is synchronizable by a clock generator. The control unit is preferably designed as a microcontroller. According to the invention, the timepiece device further comprises at least two crystal oscillators each of them built respectively by at least one crystal unit. A first crystal oscillator with a predetermined nominal oscillation frequency comprises a first crystal unit and is suitable for use as a clock generator of the control unit during a vehicle standby mode, and whereby the oscillation frequency of the first crystal oscillator is at least temporarily measured and adjustable by a second crystal oscillator with a second crystal unit whose nominal oscillation frequency is higher than those of the first crystal oscillator.

The timepiece device can be designed as an analogue or digital timepiece with an analogue and/or digital visualization of the time or as a device, which communicates the time to another device or instrument coupled to the timepiece device. The crystal oscillators are realized respectively by at least one crystal unit and an additional oscillation circuitry, whereby the oscillation circuitry is built in the control unit. Alternatively the additional oscillation circuitry is realized by other electronic components as well. The main component of the crystal oscillator is the crystal unit which defines the oscillation frequency.

By using the first crystal oscillator with the first crystal unit, which includes a relatively low oscillation frequency as a clock generator during the vehicle standby mode, wherein the vehicle is not in use e.g. when parked, a current consumption of the timepiece device is significantly reduced, such that the vehicle may be parked for an extended time period without the battery fully discharged. During the vehicle standby mode, the second crystal oscillator with the second crystal unit, which includes a relatively high and precise oscillation frequency, is only running temporarily. Preferably, the second crystal oscillator measures the oscillation frequency of the first crystal oscillator every minute or every two minutes and is inactivated during the time between the measurements. Thereby, a current consumption of the control unit is lower by using of the first crystal oscillator than by using of the second crystal oscillator as the clock generator. This is justified by the lower frequency of the first crystal oscillator since the current consumption of the control unit is proportional to the operating oscillation frequency. Preferably, this allows the achievement of an average current consumption specification in the vehicle standby mode of below to 100 microamperes (=100 μA) at room temperature (approximately 25° C.).

In a preferred embodiment of the invention, the nominal oscillation frequency of the first crystal oscillator is below 0.1 megahertz (=0.1 MHz), in particular 32.768 kilohertz (kHz). Preferably, this frequency is achieved by using of a tuning fork crystal unit, which is widely known and thus a less expensive clock generator of the analogue timepiece during the vehicle standby mode. Therefore, the first crystal oscillator comprises at least one tuning fork crystal unit, which is coupled to the control unit or other oscillation circuit. Moreover, a tuning fork crystal unit includes frequency deviations of up to 200 parts per million (=200 ppm) in an entire temperature range between −40 degrees Celsius (=−40° C.) and 85 degrees Celsius (=85° C.).

Further, the nominal oscillation frequency of the second crystal oscillator is higher than 0.5 MHz, in particular 12 MHZ. Preferably, this frequency is achieved by using of an AT-cut crystal unit with frequency deviations of up to 35 ppm in the entire temperature range between −40° C. and 85° C. Therefore, the second crystal oscillator comprises at least one AT-cut crystal unit, which is coupled to the control unit or some other oscillation circuit.

Thereby, a temperature-dependent frequency deviation of the second crystal oscillator is lower than those of the first crystal oscillator. This allows the use of the second crystal oscillator for a suitable reference oscillation frequency.

In a method of operation of a timepiece device, in particular for a vehicle, comprising a control unit for timekeeping, which is synchronized by a clock generator, a nominal oscillation frequency of a first crystal oscillator is at least temporarily measured and adjusted by a second crystal oscillator whose nominal oscillation frequency is higher than that of the first crystal oscillator.

The method according to the invention is a cost effective method for achieving a very low average standby consumption current of the analogue timepiece in combination with a very high accuracy of the maintained time, in the wide automotive temperature range between −40° C. and +85° C.

As the oscillation frequency of the second crystal oscillator depends also on the temperature, an operating temperature of a second crystal unit of the second crystal oscillator is measured in predetermined time periods. Preferably, the operating temperature is measured by a temperature sensor.

Based on the temperature measurement of the second crystal unit, an expected deviation of the oscillation frequency is known by a temperature curve provided by the supplier of the second crystal unit, i.e. it is known what the actual oscillation frequency of the second crystal oscillator should be. As a result a periodic temperature compensation of the second crystal unit is performed. Preferably, the temperature compensation is performed only by software, so that there is no need for special hardware.

Details of the present invention are described hereinafter. However, it should be understood that the detailed description and the specific examples indicate possible embodiments of the invention and are given by way of illustration only. Various changes and modifications of the illustrated embodiments within the spirit and scope of the invention are appreciated by those skilled in the art.

### BRIEF DESCRIPTION OF THE DRAWINGS

The present invention will be better understood from the detailed description given in the following. The accompanying drawings are given for illustrative purposes only and do not limit the scope of the present invention.

FIG. 1 shows a schematic view of an embodiment of a timepiece device according to the invention,

FIG. 2 shows a schematic diagram of characteristic lines of a first crystal oscillator as a function of ambient temperature, and

FIG. 3 shows a schematic diagram of characteristic lines of a second crystal oscillator as a function of ambient temperature.

### DETAILED DESCRIPTION OF THE PREFERRED EMBODIMENTS

FIG. 1 shows an embodiment of a timepiece device 1 designed as an analogue timepiece, whereby a time is displayed by two hands 1.1, 1.2 on a dial 1.3. Such analogue timepiece device 1 is preferably arranged in a vehicle's dashboard.

The timepiece device 1 is controlled by a control unit 2 such as a microcontroller or some other oscillation circuit, whereby the hands 1.1, 1.2 are driven by a stepper motor 1.4. The stepper motor 1.4 in turn is controlled by the control unit 2, which is coupled to a first crystal unit 3.1 as a part of a first crystal oscillator and a second crystal unit 3.2 as a part of a second crystal oscillator. These crystal oscillators respectively further comprise an additional oscillation circuitry, whereby the oscillation circuitry is built in the control unit 2. Alternatively the necessary oscillation circuitry is realized by other electronic components as well.

Further, the control unit 2 and the second crystal unit 3.2 and thus the second crystal oscillator are coupled to a temperature sensor 4, which will be described in more detail in FIG. 3.

Most of the known microcontrollers certified for use in a vehicle have a current consumption factor of about 500 microampere (=500 μA) per 1 megahertz (=1 MHz) or even higher. As the timepiece device 1 contains also the stepper motor 1.4, additionally a zero point detection circuit, a vehicle bus (Local Interconnect Network=LIN or Controller Area Network=CAN) transceiver, etc. the requirement for the current consumption of the control unit 2 is very high. For example, the timepiece device 1 is connected to a vehicle network via a LIN bus.

The low average current consumption requirement of the timepiece device 1 in the present embodiment of preferably less than 100 μA in a standby mode of the vehicle, leads to the requirement of using a very low frequency for time keeping. It should contribute to the overall consumption of the control unit 2 with not more than 20 μA average current.

In the context of this specification, the standby mode of the vehicle is a mode, in which the vehicle is not in use, such as when being parked.

To achieve the required low current consumption, the first crystal oscillator is used as a clock generator in the control unit 2 during standby mode of the vehicle.

The first crystal oscillator is preferably a common quartz clock with the first crystal unit 3.1 designed as a tuning fork crystal unit with a nominal oscillation frequency of 32.768 kilohertz (=32.768 kHz). The first crystal unit 3.1 includes preferably no special requirements. Such a first crystal unit 3.1 with a relatively low oscillation frequency allows a very low current consumption of the timepiece device 1 during the standby mode of the vehicle. Alternatively the first crystal oscillator may include a first crystal unit 3.1 with any other nominal oscillation frequency below 0.1 MHz.

In general, a crystal oscillator is an electronic oscillator circuit and is used for generation and/or stabilization of an electric oscillation, in particular to keep track of time. Thereby, the crystal oscillator uses the mechanical resonance of a vibrating crystal of piezoelectric material to generate an electric signal with a very precise frequency. Further a crystal oscillator consists of a monocrystalline piezoelectric quartz crystal unit whose size and orientation with respect to the crystallographic axes, also known as crystal cut, determine the oscillation frequency of the crystal oscillator.

A further requirement is an oscillation frequency accuracy, whereby an oscillation frequency deviation f_{d} should be less than or equal to ±23 parts per million (=±23 ppm) in an entire temperature range between −40 degrees Celsius (=−40° C.) and 85 degrees Celsius (=85° C.). This is because a timepiece device time error should be less than two seconds per 24 hours.

Unfortunately, such high temperature stability cannot be achieved by the first crystal unit 3.1, whereby the first crystal unit 3.1 cannot be determined with such accuracy even in case an operating temperature of it is exactly known.

This is because the oscillation frequency deviation f_{d} of crystal oscillators such as the first crystal unit 3.1 is determined by the following equation:

$$\frac{Δ f}{f} ( T ) = \frac{Δ {f}_{0}}{f} + {α ( T - {T}_{0} )}^{2} \qquad [ 1 ]$$

### Whereas

$$\frac{Δ {f}_{0}}{f}$$

is the initial (or mechanical) frequency tolerance of the suitable crystal unit, in particular the first crystal unit 3.1, at the temperature T₀; T₀ is the turn-over temperature, provided by the crystal unit specification, normally 25° C.±5° C.; T is the ambient temperature; and α is coefficient, provided by the suitable crystal unit specification, normally −0.04 ppm/° C.².

FIG. 2 shows a diagram of characteristic lines of oscillation frequency deviations f_{d} of a first crystal oscillator as a function of ambient temperature T.

The diagram has the oscillation frequency deviation f_{d} with the unit ppm as ordinate and the ambient temperature T with the unit ° C. as abscissa.

A first characteristic line L1.1 (shown as a solid line) represents the oscillation frequency deviation f_{d} of the first crystal oscillator with a first crystal unit 3.1 having a turn over temperature of 20° C., whereby a second characteristic line L1.2 (shown as a dashed line) represents the oscillation frequency deviation f_{d} of the first crystal oscillator with a first crystal unit 3.1 having a turn over temperature of 25° C. and a third characteristic line L1.3 (shown as a dot-dashed line) represents the oscillation frequency deviation f_{d} of the first crystal oscillator with a first crystal unit 3.1 having a turn over temperature of 30° C. Thereby, the second characteristic line L1.2 is a typical line and the first and third characteristic line L1.1, L1.3 are the worst cases related to the turnover temperature T₀.

Assuming the initial (mechanical) frequency tolerance at room temperature is measured and compensated (stored) by software, the temperature dependent term remains α(T−T₀)². As the uncertainty of the turnover temperature T₀ is ±5° C., the estimated oscillation frequency deviation f_{d} is between:

0.04(T−(25+5))²<deviation<−0.04(T−(25−5))² [2]

or

0.04(T−30)²<deviation<−0.04(T−20)² [3]

When the ambient temperature T is −40° C., the oscillation frequency deviation f_{d} is between −196 ppm and −144 ppm, i.e. the inaccuracy range is 52 ppm or ±26 ppm.

When the ambient temperature T is 85° C., the oscillation frequency deviation f_{d} is between −169 ppm and −121 ppm, i.e. the inaccuracy range is 48 ppm or ±24 ppm.

The best accuracy of the oscillation frequency of the first crystal unit 3.1 is given by an ambient temperature T of 25° C. Higher or lower ambient temperatures T increase the oscillation frequency deviation f_{d} and thus reduce the accuracy of the timepiece device 1 such that the required accuracy of the timepiece device 1 in the standby mode of the vehicle is not reachable at all ambient temperatures T.

To solve this problem, it is necessary to measure the actual oscillation frequency of the first crystal oscillator periodically in predeterminable intervals.

This is performed by the second crystal oscillator having a nominal oscillation frequency of 12 MHZ. Preferably the second crystal unit 3.2 of the second crystal oscillator is designed as an AT-cut crystal unit. Alternatively the second crystal oscillator may include any other AT-cut crystal unit with a nominal oscillation frequency in a range between 0.5 MHz and 200 MHz.

In a conventional operation of the timepiece device 1, i.e. during the vehicle being in use, the second crystal oscillator is used as the clock generator of the control unit 2 because when the vehicle is in use the current consumption requirements are not so strict as in the standby mode of the vehicle.

AT-cut crystal units are singularly rotated Y-axis cuts in which the top and bottom half of the crystal move in opposite directions during oscillation. Furthermore, AT-cut crystal units are easy to manufacture and characterized by a very precise frequency. Thus, in comparison with the first crystal oscillator, the second crystal oscillator is characterized by a lower temperature dependency and hence a lower oscillation frequency deviation f_{d} at different ambient temperatures T. This fact is shown in FIG. 3.

FIG. 3 shows characteristic lines of an oscillation frequency deviation f_{d} of a second crystal unit 3.2 as a function of ambient temperature T.

A first characteristic line L2.1 (the center curve; shown as a dot-dashed line) represents the oscillation frequency deviation f_{d} of the second crystal oscillator with a second crystal unit 3.2 at an angle of 35°15′, whereby a second characteristic line L2.2 (minimum curve; shown as a dashed line) represents the oscillation frequency deviation f_{d} of the second crystal oscillator with a second crystal unit 3.2 at an angle of 35°15′ plus negative cutting angle tolerance and a third characteristic line L2.3 (maximum curve; shown as a solid line) represents the oscillation frequency deviation f_{d} of the second crystal oscillator with a second crystal unit 3.2 at an angle of 35°15′ plus positive cutting angle tolerance.

Characteristic lines of any other AT-cut crystal units are between the second and third characteristic line L2.2, L2.3.

The diagram shows that the amplitude of the oscillation frequency deviations f_{d} of the second crystal oscillator (first characteristic line L2.1) is ±20 ppm in the above described entire temperature range (−40° C. to 85° C.). The magnitude of the oscillation frequency deviations f_{d} (the difference between the second characteristic line L2.2 and the third characteristic line L2.3) depends on the cutting angle tolerances of the second crystal unit 3.2.

The shown maximum absolute oscillation frequency deviation f_{d} of the second crystal oscillator is usually separated in two ranges R1, R2 (shown as boxes), wherein the first range R1 is a temperature range between −20° C. and +70° C. and the oscillation frequency deviation f_{d} in this range is maximal ±10 ppm. The second range R2 is the entire temperature range temperature range between −40° C. and +85° C. and the oscillation frequency deviation f_{d} in this range is maximum ±35 ppm.

The second crystal unit 3.2 also has an initial (mechanical) frequency offset at an ambient temperature T of 25° C. with a specified maximum value, for example maximal ±10 ppm at 25° C. This initial frequency offset is not temperature-dependent. All AT-cut crystal units from the respective series have their own mechanical offsets inside this range.

So, the absolute accuracy of the first range R1 around the ambient temperature T with 25° C. is high enough, but the accuracy in the second range R2 is not enough.

However, it is useful to determine the maximum difference between the first and second characteristic line L2.1, L2.2, as well as the maximum difference between the first and the third characteristic line L2.1, L2.3 for each ambient temperature T in the second range R2.

Therefore, a method for operation of the timepiece device 1 uses the first characteristic line L2.1, provided by the supplier of the second crystal unit 3.2 and the ambient temperature T of the second crystal unit 3.2 periodically is measured by the temperature sensor 4, arranged close to the second crystal unit 3.2. Preferably, the temperature sensor 4 provides a moderate temperature accuracy of ±3° C.

The temperature of the second crystal unit 3.2 is measured often, for example every one or two minutes during the standby mode of the vehicle.

Based on the temperature measurement of the second crystal unit 3.2, the expected oscillation frequency deviation f_{d} is known, i.e. it is known what the actual oscillation frequency of the second crystal unit 3.2 should be. The maximum inaccuracy in this case is the difference between the first characteristic line L2.1 and an actual characteristic line of the second crystal unit 3.2, somewhere between the second and third characteristic lines L2.2, L2.3.

From the present diagram, it is obvious that the maximum difference between the first and the second characteristic line L2.1, L2.2 and between the first and third characteristic line L2.1, L2.3 is not more than ±10 ppm.

Additionally, the initial oscillation frequency tolerance of ±10 ppm at the ambient temperature T of 25° C. as described above has to be added.

In this case the second crystal oscillator will provide a reference oscillation frequency with a maximum oscillation frequency deviation f_{d} of ±20 ppm at worst.

To be more precisely, periodically, every one or two minutes the temperature of the second crystal unit 3.2 is measured and the oscillation frequency deviation f_{d} of the second crystal oscillator is evaluated. After that, by using of the measured oscillation frequency of the second crystal oscillator an oscillation frequency deviation f_{d} of the first crystal unit 3.1 is measured. After each measurement a dimension of a time error is calculated, i.e. it is calculated how big a time error is since the last measurement.

The time error is stored as a signed 32-bit variable, the chosen unit is one tick of the second crystal oscillator. Positive value means are additional ticks to add to the time, so if the error is 12 million, this means one second is to be added to the time, in order to compensate the accumulated error. Logically negative values (=x) below minus 12 million are compensated by subtracting x/12000000 seconds from the time.

The above described temperature compensation is preferably performed by software only. With this, there is no need to perform any oscillation frequency or temperature calibration during a manufacturing of the analogue timepiece as the method according to the invention is robust enough and the accuracy is defined only by the specification of the used second crystal unit 3.2.

As a result, it can be said that the method for operation of the timepiece device 1 allows a low average consumption current in standby mode with lower than 100 μA (at T=25° C.), while keeping the timepiece accuracy better than 2 seconds per 24 hours (˜23 ppm) in the entire temperature range between −40° C. and 85° C.

The achieved accuracy of the timepiece device 1 in the standby mode of the vehicle is better than the accuracy that would be achieved if only the second crystal oscillator without temperature compensation as the timekeeping crystal oscillator is used.

Further, the method is not limited to the mentioned requirements regarding to the current consumption and/or the temperature range and/or the accuracy of the timepiece device 1 in the vehicle standby mode and/or when the vehicle is in use. The method could be used for other specification requirements, for example to require an average current of 150 μA or to require another accuracy, in other temperature ranges.

The timepiece device 1 according to the invention is not limited to an analogue timepiece. It may be designed as a digital timepiece with an analogue and/or digital visualization of the time or as a device, which communicates the time to another device or instrument coupled to the timepiece device 1.

### LIST OF REFERENCES

1 timepiece device
1.1, 1.2 hands
1.3 dial
1.4 stepper motor
2 control unit
3.1 first crystal unit
3.2 second crystal unit
4 temperature sensor
f_{d} oscillation frequency deviation
L1.1, L2.1 first characteristic lines
L1.2, L2.2 second characteristic lines
L1.3, L2.3 third characteristic lines
R1 first range
R2 second range
T ambient temperature

1. A timepiece device, comprising:
a clock generator; and
a control unit for timekeeping, which is synchronizable by the clock generator,
wherein the clock generator includes at least two crystal oscillators built respectively by at least one crystal unit, wherein a first crystal oscillator with a first crystal unit and with a predetermined nominal oscillation frequency is suitable for use as the clock generator of the control unit during a vehicle standby mode, and the oscillation frequency of the first crystal oscillator is at least temporarily measured and adjustable by a second crystal oscillator with a second crystal unit whose nominal oscillation frequency is higher than that of the first crystal oscillator.

2. The timepiece device according to claim 1, wherein the nominal oscillation frequency of the first crystal oscillator is below 0.1 MHz.

3. The timepiece device according to claim 1, wherein the first crystal unit is a tuning fork crystal unit.

4. The timepiece device according to claim 1, wherein the nominal oscillation frequency of the second crystal oscillator is higher than 0.5 MHz.

5. The timepiece device according to claim 1, wherein the second crystal unit is an AT-cut crystal unit.

6. The timepiece device according to claim 1, wherein a temperature-dependent frequency deviation of the second crystal oscillator is lower than that of the first crystal oscillator.

7. A method of operation of a timepiece device comprising a control unit for time keeping, which is synchronized by a clock generator, the method comprising:
measuring and adjusting a nominal oscillation frequency of a first crystal oscillator at least temporarily in a vehicle standby mode by a second crystal oscillator whose nominal oscillation frequency is higher than that of the first crystal oscillator.

8. The method according to claim 7, further comprising measuring an operating temperature of a second crystal unit of the second crystal oscillator in predetermined time periods.

9. The method according to claim 8, further comprising performing, as a function of the measured operating temperature of the second crystal unit, a periodic temperature compensation of the second crystal unit.
